(19) United States
(12) Patent Application Publication
(10) Pub. No.: US 2020/0378479 A1
(43) Pub. Date: Dec. 3, 2020

(54) SEALED TENSIONER

(71) Applicant: BorgWarner, Inc., Auburn Hills, MI (US)

(72) Inventors: Zachary Perrella, Ithaca, NY (US); Adam Hunt, Brooktondale, NY (US)

(21) Appl. No.: 16/425,367

(22) Filed: May 29, 2019

(51) Int. Cl. F16H 7/08

(52) U.S. Cl. CPC F16H 7/0848; F16H 2007/0812; F16H 2007/0859; F16H 7/0836

(57) ABSTRACT

A sealed tensioner includes a body having a high-pressure chamber; a low-pressure reservoir that is in fluid communication with the high-pressure chamber through a fluid conduit; a piston received by the body that moves axially to compress fluid in the high-pressure chamber; a seal positioned between the piston and the body that prevents passage of fluid from the high-pressure chamber between the piston and the body; and a check valve, regulating fluid flow between a low-pressure reservoir and the high-pressure chamber, including a stiffness control aperture.

### TECHNICAL FIELD

The present application relates to tensioners of chains and belts used with an internal combustion engine (ICE) and, more particularly, to tensioners that lack an outside fluid supply.

### BACKGROUND

The relative angular position between camshafts and crankshafts of internal combustion engines (ICEs) are typically fixed. Endless loops in the form of a chain or a belt drive configuration are common ways to carry this out. Sprockets or gears included on distal ends of the camshafts and crankshafts are linked by the belt or chain drive configuration. In addition, other components of the ICE are also engaged by the belt or chain drive configuration such as front-end accessory drive components.

The belts or chains are commonly equipped with tensioners to help keep the belts and chains properly tensioned as they wear and stretch with use. Some tensioners are spring loaded while others are hydraulically operated. A conventional hydraulically-operated tensioner may be fed from an external oil supply, such as one that may be provided by the ICE. This usually means that the ICE and the tensioner have dedicated oil passages communicating with each other. The outside oil supply may be an unwanted parasitic loss on the engine, among other potential drawbacks.

### SUMMARY

In one implementation, a sealed tensioner includes a body having a high-pressure chamber; a low-pressure reservoir that is in fluid communication with the high-pressure chamber through a fluid conduit; a piston received by the body that moves axially to compress fluid in the high-pressure chamber; a seal positioned between the piston and the body that prevents passage of fluid from the high-pressure chamber between the piston and the body; and a check valve, regulating fluid flow between a low-pressure reservoir and the high-pressure chamber, including a stiffness control aperture.

In another implementation, a sealed tensioner has a body including a high-pressure chamber; a low-pressure reservoir formed in the body that is in fluid communication with the high-pressure chamber through a fluid conduit; a piston received by the body that moves axially to compress fluid in the high-pressure chamber; a seal positioned between the piston and the body that prevents passage of fluid from the high-pressure chamber between the piston and the body; and a check valve, positioned substantially coaxially with the high-pressure chamber, regulating fluid flow between the low-pressure reservoir and the high-pressure chamber, including a stiffness control aperture.

In yet another implementation, a sealed tensioner has a body including a high-pressure chamber; a low-pressure reservoir formed in the body that is in fluid communication with the high-pressure chamber through a fluid conduit; a piston received by the body that moves axially to compress fluid in the high-pressure chamber; a seal positioned between the piston and the body that prevents passage of fluid from the high-pressure chamber between the piston and the body; and a check valve, positioned substantially coaxially with the low-pressure reservoir, regulating fluid flow between the low-pressure reservoir and the high-pressure chamber, including a stiffness control aperture.

### BRIEF DESCRIPTION OF THE DRAWINGS

FIG. 1 is a perspective view depicting an implementation of a sealed tensioner;

FIG. 2 is a cross-sectional view depicting an implementation of the sealed tensioner;

FIG. 3 is another cross-sectional view depicting an implementation of the sealed tensioner;

FIG. 4 is a cross-sectional view of another implementation of a sealed tensioner; and

FIG. 5 is a cross-sectional view of another implementation of a sealed tensioner.

### DETAILED DESCRIPTION

A sealed tensioner includes a piston acted on by fluid in a high-pressure chamber, a low-pressure reservoir that is spaced apart from the high-pressure chamber and fluidly linked with the high-pressure chamber by a check valve, and a body that receives the piston. A seal fits over an outer surface of the piston and prevents the escape of fluid between the piston and the body that receives it, from the high-pressure chamber into either the low-pressure chamber or the atmosphere. In the past, sealed tensioners could vary the amount of hydraulic stiffness or damping of a piston when acted on by a chain or belt by permitting the escape of some fluid between an exterior surface of the piston and the walls of a cylinder receiving the piston. An amount of clearance between the piston and the cylinder wall could be deliberately chosen based on an amount of hydraulic stiffness or compliance desired. Greater amounts of clearance could result in a sealed tensioner that is less hydraulically stiff or damped relative to a sealed tensioner having a relatively smaller amount of clearance. However, sealed tensioners permitting the flow of fluid between the piston and the cylinder wall may be limited in the amount of fluid that can flow between the low-pressure reservoir and the high-pressure chamber through the check valve. For instance, the diameter of a check valve may be constrained by the outer diameter of a piston when the check valve is positioned axially between a low-pressure reservoir and a high-pressure chamber.

In contrast, the sealed tensioners disclosed include a low-pressure reservoir that can be located apart from the high-pressure chamber and a check valve can regulate the flow of fluid between the reservoir and the chamber through a fluid conduit. The diameter of the check valve can be determined independently of the diameter of the piston or the diameter of the cylinder receiving the piston. The increase in diameter of the check valve can increase the rate of fluid flow between the low-pressure reservoir to the high-pressure chamber through an opening of the check valve regulated by a valve member, increasing responsiveness, while permitting the use of a smaller-diameter piston. The low-pressure reservoir can be located in the body of the tensioner adjacent to the high-pressure chamber or the reservoir can be located apart from the body. Hydraulic stiffness and/or damping of the tensioner can be implemented and determined by one or more stiffness control apertures formed in the check valve that permit fluid flow through the check valve even though one or more check valve members are biased into or exist in a closed position. While the term “apertures” is used, this is intended to broadly include defined fluid passageways such as grooves, channels, capillaries, and other such fluid conduits. The size, shape, and quantity of the apertures can be selected based on a desired amount of relative hydraulic stiffness and/or damping. Increased size and/or quantity of apertures can decrease the amount of stiffness/damping and reduced size and quantity of apertures can increase the stiffness/damping. The apertures or pathways in the check valve used to regulate stiffness/damping in conjunction with a seal between the piston and the cylinder or body can help the sealed tensioner maintain hydraulic stiffness/damping regardless of operating temperature and fluid viscosity, relative to sealed tensioners that permit fluid to escape between the piston and the cylinder wall. The apertures or pathways also help maintain hydraulic stiffness/damping when a body is constructed from a material having a different coefficient of thermal expansion than the material used to construct the piston.

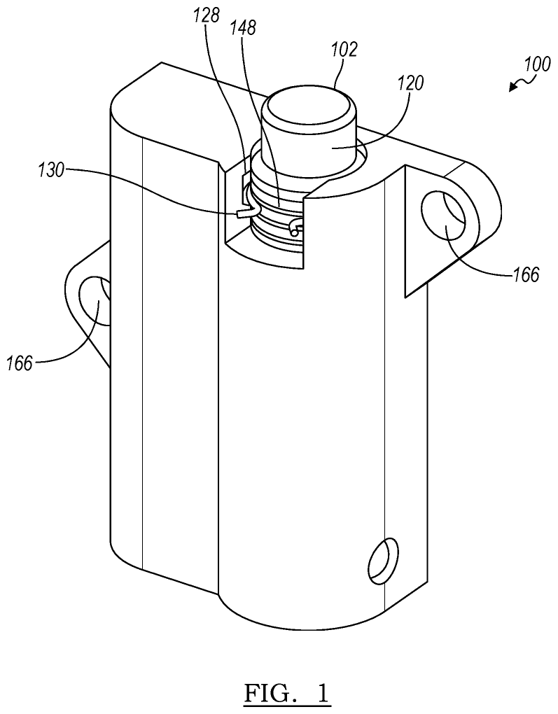

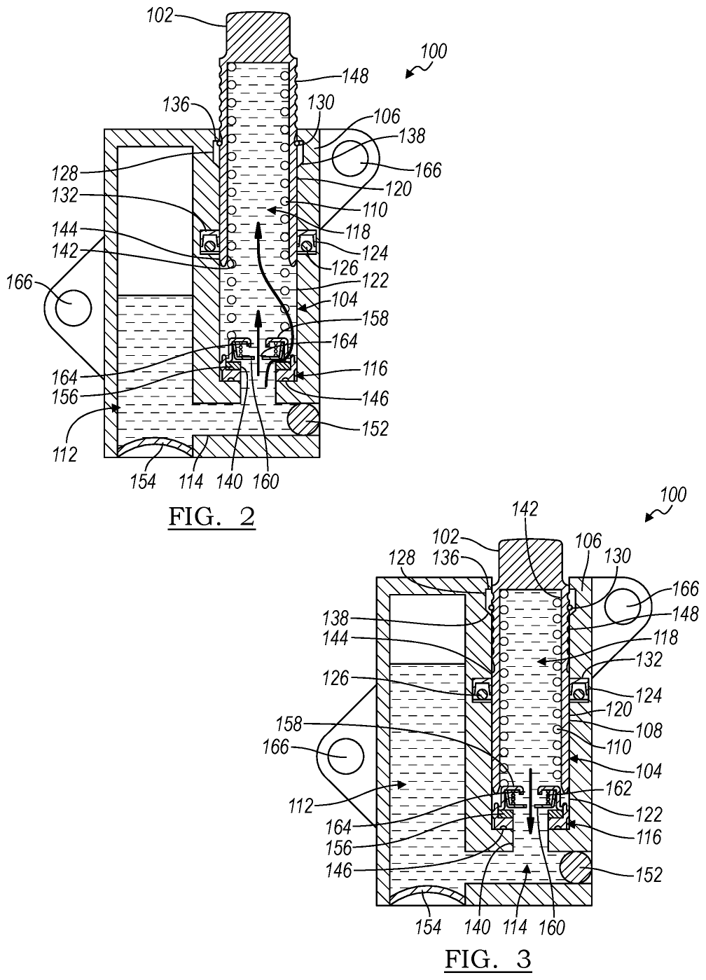

Turning now to FIGS. 1-3, an implementation of a sealed tensioner 100 is shown. The tensioner 100 includes a piston 102 that at least partially includes a high-pressure chamber 104, a body 106 having a cylinder 108 for receiving the piston 102, a spring 110 positioned in between the piston 102 and the cylinder 108 located in the high-pressure chamber 104, a low-pressure reservoir 112 located within the body 106 adjacent the high-pressure chamber 104, a fluid conduit 114 fluidly connecting the high-pressure chamber 104 and the low-pressure reservoir 112, and a check valve 116 that can regulate fluid flow between the low-pressure reservoir 112 and the high-pressure chamber 104.

The body 106 includes cavities and fluid passageways within the body 106 that fluidly communicate with each other. A high-pressure cavity 118 receives the piston 102 and at least partially defines the high-pressure chamber 104 of the tensioner 10. The high-pressure cavity 118 can have a surface that closely conforms to an outer surface 120 of the piston 102 and permits the piston 102 to slide axially relative to the high-pressure cavity 118. In this implementation, the high-pressure cavity 118 can have a cylindrical shape and a circular cross-section but it should be appreciated that the piston 102 and high-pressure cavity 118 can have different corresponding cross-sectional shapes. A surface 122 of the high-pressure cavity 118 can include a recess 124 for receiving a piston seal 126 and another recess 128 for receiving a ratchet clip 130 carried by the piston 102. The piston seal 126 can fit into the piston seal recess 124 and be constrained from axial movement by a seal retainer 132 and/or a snap ring 134. The piston seal 126 can abut both the body 106 of the tensioner 100 and the piston 102 to form a fluid-tight seal preventing the fluid in the high-pressure chamber 104 from escaping between the piston 102 and the body 106. In one embodiment, the piston seal 126 can be an elastomeric material that is resilient to the heat generated by ICEs. The ratchet clip recess 128 can have an upper annular shoulder 136 and a lower annular shoulder 138 that selectively prevents the axial movement of the piston 102. The high-pressure cavity 118 can have a closed end 146 with a fluid bore 140 through which fluid passes between the low-pressure reservoir 112 and the high-pressure cavity 118.

The piston 102 can be received by the high-pressure cavity 118 and slide axially with respect to the cavity 118. The piston 102 can include an inner diameter 142 and an outer diameter 144 such that the piston 102 is hollow along a portion of its axial length. The hollow portion of the piston 102 along with the high-pressure cavity 118 can collectively form the high-pressure chamber 104. The spring 110 can be positioned in the high-pressure chamber 104 in between the closed end 146 and extending within the piston 102 urging the piston 102 away from the body 106. In this implementation, the outer surface 120 of the piston 102 includes a plurality of grooves 148 that receive the ratchet clip 130. As the piston 102 moves axially with respect to the cylinder 108 and away from the body 106, the grooves 148, in concert with the upper annular shoulder 136, expand the ratchet clip 130 radially, outwardly with respect to the piston 102 to permit the piston 102 to extend away from the body 106. As the piston 102 is forced toward the body 106, by a chain or belt, the lower annular shoulder 138 directs the ratchet clip 130 radially inwardly toward the piston 102 thereby preventing the axial movement of the piston 102 into or toward the body 106. The ratchet clip 130 prevents the piston 102 from extending too far from the body 106 and compensates for chain or belt wear over time.

Another cavity can be formed in the body 106 for the low-pressure reservoir 112 and fluidly connected to the high-pressure cavity 118 by the fluid conduit 114. The high-pressure cavity 118, the low-pressure reservoir 112, and the fluid conduit 114 can be formed in a variety of ways. In one implementation, the body 106 is formed from metal and could be created using a sandcasting technique. Or the body 106 could be formed from a solid unit of metal and the high-pressure cavity 118, the low-pressure reservoir 112, and the fluid conduit 114 can be created using a machine tool and a spindle that drills into the solid unit of metal removing material thereby creating the cavities and conduit. Portions of the body 106 that were used or created during the formation of the cavities and conduit can then be sealed using plugs that may be force fit or threaded into fluid-tight engagement with the body 106. In this implementation, a ball plug 152 is press fit into engagement with the body 106 thereby sealing the fluid conduit 114 and a freeze plug 154 is inserted into the body 106 sealing the low-pressure reservoir 112 from the atmosphere. While in this implementation the low-pressure reservoir 112 is shown to be included in the body 106, other implementations are possible in which the low-pressure reservoir 112 is located remotely, apart from the body 106 of the tensioner 100.

The check valve 116 may be positioned at the closed end 146 of the high-pressure cavity 118 regulating the flow of fluid. In this implementation, the check valve 116 can include a valve seat 156, a retainer 158, a cupped disk 160, and a biasing element 162 that releasably biases the cupped disk 160 into sealing engagement with the valve seat 156. Fluid can be drawn into the high-pressure chamber 104 as the cupped disk 160 moves away from the valve seat 156 permitting the flow of fluid through the fluid bore 140. However, even if the cupped disk 160 remains engaged with the valve seat 156 the check valve 116 can permit the bidirectional flow of fluid into and out of the high-pressure chamber 104. The cupped disk 160 can include a stiffness control aperture 164 that permits the bidirectional flow of fluid through the check valve 116 while the cupped disk 160 is engaged with the valve seat 156. This implementation of a check valve 116 can also be referred to as a two-way valve. An example of a similar valve that includes a valve seat, a retainer, a cupped disk, and a biasing element is described in U.S. Pat. No. 10,006,524, the contents of which are incorporated by reference. One or more stiffness control apertures 164 can be cut into the cupped disk 160 at a size depending on the hydraulic stiffness or damping desired. In one implementation, the stiffness control aperture 164 can be 0.4 millimeters (mm) in diameter for a tensioner that is relatively stiff or has a high level of stiffness. Or in another implementation the stiffness control aperture can be 1.0 mm in diameter for a relaxed tensioner having a relatively low level of stiffness. However, it should be appreciated that other implementations of check valves 116 are possible as well. For example, a ball-style valve can include a stiffness control aperture 164 adjacent a point at which the ball engages a valve seat. Or in another implementation the stiffness control aperture 164 can be formed as a fluid conduit within the valve seat 156 that communicates fluid between the high-pressure chamber 104 and the low-pressure reservoir 112. While the implementation here includes one check valve, a tensioner could include more than one check valve each having one or more stiffness control apertures.

The check valve 116 in this implementation is positioned substantially coaxially with the piston 102 and the cylinder 108 receiving the piston 102 at the closed end 146 adjacent the fluid bore 140. The check valve 116 can have a diameter substantially the same as a maximum diameter of the high-pressure chamber 104 and/or the maximum diameter of the cylinder 108 receiving the piston 102. However, other implementations are possible in which the check valve 116 is located in the fluid conduit 114, an end of the low-pressure reservoir 112, or another location in a fluid stream between the low-pressure reservoir 112 and the high-pressure chamber 104.

The low-pressure reservoir 112 and the high-pressure chamber 104 can be filled with fluid, such as engine oil, before the plugs 152, 154 are attached to the body 106 sealing off the tensioner 100 such that fluid cannot escape. The body 106 can include one or more attachment points 166 that physically link the sealed tensioner 100 to an internal combustion engine (ICE) such that the piston 102 is in position to add tension to a chain or belt carried by the ICE. A retaining feature (not shown), such as a pin, can maintain the piston 102 relative to the body 106 so that the sealed tensioner 100 can be installed on the ICE without the piston 102 interfering with the chain or belt. Once attached to the ICE, the retaining feature can release the piston 102 relative to the body 106 and the spring 110 can urge the piston 102 into contact with an element, such as a pulley or a pivoting arm, that engages the chain or belt. As the piston 102 moves axially away from the body 106 of the sealed tensioner 100 and adds force to the chain or belt thereby tightening it, fluid from the low-pressure reservoir 112 can move the cupped disk 160 away from the valve seat 156 permitting fluid to flow from the low-pressure reservoir 112 through the fluid conduit 114 and into the high-pressure chamber 104. When the chain or belt exerts force against the piston 102, some fluid in the high-pressure chamber 104 can be prevented from re-entering the low-pressure reservoir 112 by the cupped disk 160 pressed against the valve seat 156. However, some of the fluid in the high-pressure chamber 104 may pass through the stiffness control aperture(s) 164 into the low-pressure reservoir 112 thereby providing a defined amount of hydraulic stiffness and/or hydraulic damping based on the size of the stiffness control apertures 164. In this implementation, the tensioner 100 can be positioned with the piston 102 pointing substantially upwards ranging between 60 degrees to the right of vertical to 60 degrees to the left vertical. Or the low-pressure reservoir 112 can include baffles or a closed-cell foam (not shown) that can prevent the high-pressure chamber 104 from drawing air from the low-pressure reservoir 112 when piston 102 is positioned so that it extends downward. Or the orientation of the low-pressure reservoir can be re-positioned or re-oriented relative to the piston and/or the high-pressure chamber. In that way, the sealed tensioner 100 can be positioned with its piston 102 directed in any direction.

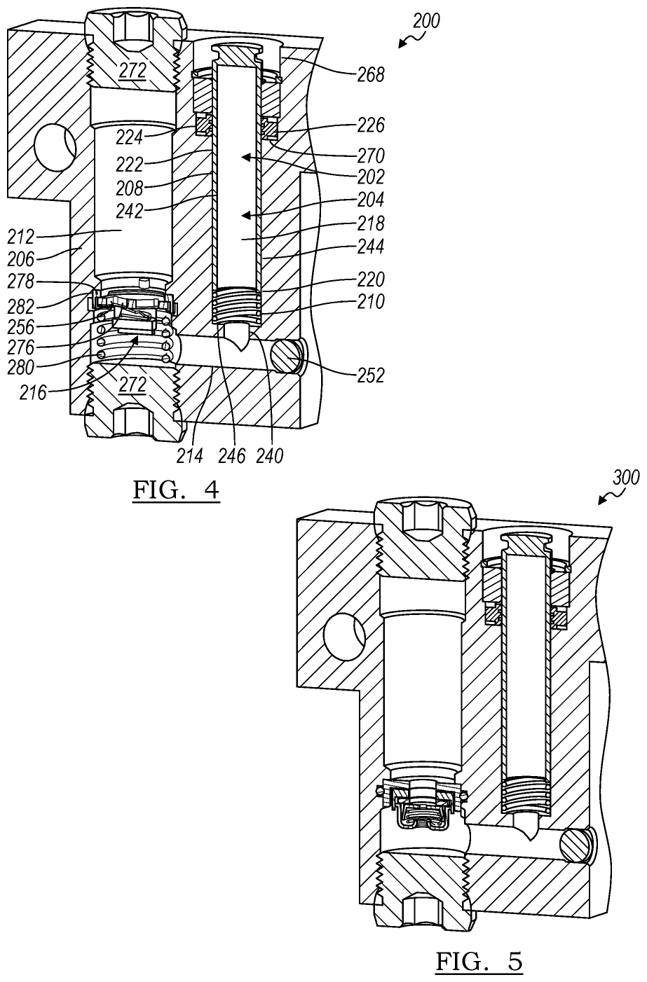

Turning to FIG. 4, another implementation of a sealed tensioner 200 is shown. The tensioner 200 includes a piston 202 that at least partially includes a high-pressure chamber 204, a body 206 having a cylinder 208 for receiving the piston 202, a spring 210 positioned in between the piston 202 and the cylinder 208 located in the high-pressure chamber 204, a low-pressure reservoir 212 located within the body 206 adjacent the high-pressure chamber 204, a fluid conduit 214 fluidly connecting the high-pressure chamber 204 and the low-pressure reservoir 212, and a check valve 216 that is not positioned substantially coaxially with the high-pressure chamber 204 and can regulate fluid flow between the low-pressure reservoir 212 and the high-pressure chamber 204. In this implementation, the outer diameter of the check valve 216 and the outer diameter of the piston 202 are independent of each other such that the outer diameter of the check valve 216 can be greater than the outer diameter of the piston 202. And the check valve 216 can be positioned substantially coaxially with the low-pressure reservoir 212.

The body 206 includes a high-pressure cavity 218 that receives the piston 202 and at least partially defines the high-pressure chamber 204 of the tensioner 200. The high-pressure cavity 218 can have a surface that closely conforms to a portion of an outer surface 220 of the piston 202 and permits the piston 202 to slide axially relative to the high-pressure cavity 218. In this implementation, the high-pressure cavity 218 can have a cylindrical shape and a circular cross-section. The high-pressure cavity 218 can include a counter bore 268 that receives a piston seal 226 and a recess for receiving a snap ring 234 that constrains the piston seal 226 from axial movement. The high-pressure cavity 218 can be closed at one end 246 with a fluid bore 240 that fluidly communicates with the fluid conduit 214 to the low-pressure reservoir 212.

The piston 202 can be received by the high-pressure cavity 218 and slide axially with respect to the cavity 218. The piston 202 can include an inner diameter 242 and an outer diameter 244 such that the piston 202 is hollow along a portion of its axial length. The hollow portion of the piston 202 along with the high-pressure cavity 218 can collectively form the high-pressure chamber 204. The spring 210 can be positioned in the high-pressure chamber 204 in between the closed end 246 and extending within the piston 202 urging the piston 202 away from the body 206. In this implementation, the outer surface of the piston 202 is substantially smooth.

Another cavity can be formed in the body 206 for the low-pressure reservoir 212 and fluidly connected to the high-pressure cavity 218 by the fluid conduit 214. In this implementation, the low-pressure reservoir 212 is formed as a bore in the body 206 that is adjacent to the high-pressure cavity 218. The bore includes an annular shoulder 270 that receives the check valve 216 and prevents the check valve 216 from moving axially with respect to the low-pressure reservoir 212. One end of the bore can receive a threaded plug 272 and another end of the bore can receive another threaded plug 272 thereby sealing the fluid inside of the tensioner 200. In this implementation, a ball plug 252 is press fit into engagement with the body 206 at one end of the fluid conduit 214 near a surface of the body 206 thereby sealing the fluid conduit 214, the high-pressure chamber 204, and the low-pressure 212 from the atmosphere. While in this implementation the low-pressure reservoir 212 is shown to be included in the body 202, other implementations are possible in which the low-pressure reservoir 212 is located remotely, apart from the body 202 of the tensioner 202.

The check valve 216 may be positioned at the closed end 246 of the high-pressure cavity 218 regulating the flow of fluid. In this implementation, the check valve 216 can include a valve seat 256 having a plurality of openings 274, a plurality of reed valves 276, and a valve body 278. A biasing element 280 can be positioned in between a threaded plug 272 and the check valve 216 thereby maintaining the check valve 216 against the annular shoulder 270. Fluid can be drawn into the high-pressure chamber 204 as the reed valves 276 move away from the valve seat 256 permitting the flow of fluid through the fluid bore 240 from the low-pressure reservoir 212. However, even if the reed valves 276 remain engaged with the valve seat 256 the check valve 216 can permit the bidirectional flow of fluid into and out of the high-pressure chamber 204.

The valve seat 256 can include a stiffness control aperture 264 to create the bidirectional flow in the form of a groove 282 in the valve seat 256 or the annular shoulder 270 or a protuberance that positions the reed valves 276 slightly apart from the valve seat 256 thereby permitting fluid flow through the check valve 216 despite the reed valves 276 being fully biased against the valve seat 256 (i.e., closed as much as possible). that permits the bidirectional flow of fluid through the check valve 216 while the reed valves 276 are engaged with the valve seat 256. The size of the groove 282 or the distance the reed valves 276 are separated from the valve seat 256 by the protuberances can be chosen based on the amount of hydraulic stiffness desired. Larger groove cross-sections or larger protuberances can increase the flow between high-pressure chamber 204 and low-pressure reservoir 212 thereby decreasing the amount of stiffness whereas smaller groove cross-sections or protuberances can increase the amount of stiffness by decreasing the flow. An example of a similar check valve that includes a valve seat having a plurality of openings, a plurality of reed valves, and a valve body is described in U.S. patent application Ser. No. 15/723,367, the contents of which are incorporated by reference. As discussed above, the diameter of the check valve is independent of the diameter of the piston, and the check valve can have a diameter substantially the larger than the high-pressure chamber and/or the diameter cylinder receiving the piston.

Turning to FIG. 5, another implementation of a sealed tensioner 300 is shown. The sealed tensioner is similar to what is described above with respect to FIG. 4, but uses a check valve having a valve seat, a retainer, a cupped disk, and a biasing element that releasably biases the cupped disk into sealing engagement with the valve seat similar to what is described above with respect to FIGS. 1-3. The sealed tensioner includes a check valve substantially coaxial with the low-pressure reservoir such that an axis drawn through a part of the low-pressure reservoir coincides with a portion of the valve seat of the check valve.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A sealed tensioner, comprising:
a body including a high-pressure chamber;
a low-pressure reservoir that is in fluid communication with the high-pressure chamber through a fluid conduit;
a piston received by the body that moves axially to compress fluid in the high-pressure chamber;
a seal positioned between the piston and the body that prevents passage of fluid from the high-pressure chamber between the piston and the body; and
a check valve, regulating fluid flow between a low-pressure reservoir and the high-pressure chamber, including a stiffness control aperture.

2. The sealed tensioner recited in claim 1, wherein the piston includes an inner diameter and an outer diameter.

3. The sealed tensioner recited in claim 1, wherein the low-pressure reservoir includes one or more baffles or closed cell foam.

4. The sealed tensioner recited in claim 1, wherein a diameter of the piston is less than a diameter of the check valve.

5. The sealed tensioner recited in claim 1, wherein the check valve includes one or more reed valves.

6. The sealed tensioner recited in claim 1, wherein the check valve comprises a cupped disk that includes the stiffness control aperture.

7. The sealed tensioner recited in claim 1, wherein the stiffness control aperture comprises a groove.

8. A sealed tensioner, comprising:
a body including a high-pressure chamber;
a low-pressure reservoir formed in the body that is in fluid communication with the high-pressure chamber through a fluid conduit;
a piston received by the body that moves axially to compress fluid in the high-pressure chamber;
a seal positioned between the piston and the body that prevents passage of fluid from the high-pressure chamber between the piston and the body; and
a check valve, positioned substantially coaxially with the high-pressure chamber, regulating fluid flow between the low-pressure reservoir and the high-pressure chamber, including a stiffness control aperture.

9. The sealed tensioner recited in claim 8, wherein the piston includes an inner diameter and an outer diameter.

10. The sealed tensioner recited in claim 8, wherein the low-pressure reservoir includes one or more baffles or closed cell foam.

11. The sealed tensioner recited in claim 8, wherein a diameter of the piston is the same as a diameter of the check valve.

12. The sealed tensioner recited in claim 8, wherein the check valve includes one or more reed valves.

13. The sealed tensioner recited in claim 8, wherein the check valve comprises a cupped disk that includes the stiffness control aperture.

14. The sealed tensioner recited in claim 8, wherein the stiffness control aperture comprises a groove.

15. A sealed tensioner, comprising:
a body including a high-pressure chamber;
a low-pressure reservoir formed in the body that is in fluid communication with the high-pressure chamber through a fluid conduit;
a piston received by the body that moves axially to compress fluid in the high-pressure chamber;
a seal positioned between the piston and the body that prevents passage of fluid from the high-pressure chamber between the piston and the body; and
a check valve, positioned substantially coaxially with the low-pressure reservoir, regulating fluid flow between the low-pressure reservoir and the high-pressure chamber, including a stiffness control aperture.

16. The sealed tensioner recited in claim 15, wherein the piston includes an inner diameter and an outer diameter.

17. The sealed tensioner recited in claim 15, wherein a diameter of the piston is different than a diameter of the check valve.

18. The sealed tensioner recited in claim 15, wherein the check valve includes one or more reed valves.

19. The sealed tensioner recited in claim 15, wherein the check valve comprises a cupped disk that includes the stiffness control aperture.

20. The sealed tensioner recited in claim 15, wherein the stiffness control aperture comprises a groove.
